(19) United States
(12) Patent Application Publication
(10) Pub. No.: US 2014/0132059 A1
(43) Pub. Date: May 15, 2014

(54) WHEEL ASSEMBLY AND VEHICLE INCORPORATING SAME

(71) Applicant: David Michael Patrick, Irvine, CA (US)

(72) Inventor: David Michael Patrick, Irvine, CA (US)

(73) Assignee: 4SPHERE LLC, Playa del Rey, CA (US)

(21) Appl. No.: 13/676,790

(22) Filed: Nov. 14, 2012

(51) Int. Cl. B60B 3/00

(52) U.S. Cl. CPC B60B 3/002
USPC 301/62

(57) ABSTRACT

A wheel assembly is provided that includes a body coupled to the central hub to rotate about the axis of rotation. The body forms an alternating pattern circumscribed about the central hub at constant radial distance from the axis of rotation. The body defines a median circle centered on and transverse to the axis of rotation. The alternating pattern of the body is evenly distributed across the median circle, resulting in an effective width greater than the width of the body. On hard surfaces, the wheel assembly provides a broad track while maintaining a relatively thin contact area, as result providing reduced friction than a traditional wheel. On soft surfaces, the wheel assembly provides substantial traction.

### FIELD OF THE INVENTION

The present invention relates generally to wheels and, more particularly, to wheels configured to be used on a variety of terrains and surfaces.

### BACKGROUND OF THE INVENTION

A wheel, in the simplest terms, is a circular component that rotates on an axle. The main advantage of a wheel is that it greatly reduces friction by rolling across a flat surface compared to sliding or dragging an object. Early wheels were simple wooden disks with a hole for an axle. At first, a cross section of a tree was used. However, this type of wheel was problematic because it did not have sufficient structural strength to support weight without breaking. It was inherently flawed because a cross section of a tree does not utilize the strength of the grain of wood, like a plank cut lengthwise. Eventually, to strengthen the wheel, three lengthwise cut planks were banded together side by side, with the axle hole bored through the centerpiece, and shaped into a circle.

Subsequently, the wheel evolved to the blueprint of the modern wheel comprising of a hub, spokes, and a rim. The advent of spokes made the wheel lighter and stronger than a solid wheel, and used less material. Further advances made to the spokes and rims resulted in wheels becoming lighter and faster. Subsequently, to prolong the durability of a wheel, covers for wheel, known today as tires, were developed as a measure to protect the wheel from damage. Initially, tires were made of simple materials such as leather, but progressed to other more durable materials such as iron and rubber.

Nonetheless, the overall circular shape has remained the same throughout the years. Presently, refinements in a wheel design have primarily been based on advancements in materials as well as, on designs adapted for specific uses, to include specific types of surfaces.

It should, therefore, be appreciated that there remains a need for a wheel assembly that is effective across a variety of surfaces. The present invention fulfills this need and others.

### SUMMARY OF THE INVENTION

Briefly, and in general terms, the invention provides a wheel assembly having a body formed as an alternating pattern circumscribed about a central hub. The body has a constant radial distance from the axis of rotation, as referenced by a median circle centered on the axis of rotation and defined by the body's alternating pattern.

More particularly, by way of example only and not limitation, the wheel can be adapted for use in any type of vehicle for transportation, such as a car, bicycle, skateboard, and wheelchair, among others. The wheel body defines an effective width (Wₑ) greater than a body width (W_{b}). On hard surfaces, the wheel assembly can provide a broad track while maintaining a relatively thin contact area in that the wheel assembly generates less friction than a traditional wheel with a comparable effective width. On soft surfaces, e.g., sand, the broad travel path of the wheel assembly enables the vehicle to travel smoothly without unduly sinking into soft material, providing substantial traction, particularly if the wheel begins to slip.

In a detailed aspect of an exemplary embodiment, the wheel body is formed of a plurality of arcs connected in sequential, adjacent alignment to circumscribe the central hub. Each arc having an arc center that is spaced apart from the axis of rotation, such that adjacent arcs have arc center on opposing sides of the body.

In another detailed aspect of an exemplary embodiment, each arc of the plurality of arcs has an arc angle of 90 degrees, in which the alternating pattern is formed of six arcs.

For purposes of summarizing the invention and the advantages achieved or implemented over the prior art, certain advantages of the invention have been described herein. Of course, it is to be understood that not necessarily all such advantages may be achieved or implemented in accordance with any particular embodiment of the invention. Thus, for example, those skilled in the art will recognize that the invention may be embodied or carried out in a manner that achieves, optimizes, or implements one advantage or group of advantages as taught herein without necessarily achieving or implementing other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a side perspective view of a vehicle incorporating wheel assemblies in accordance with the invention.

FIG. 2 is a front perspective view of the vehicle of FIG. 1.

FIG. 3 is a side perspective view of the wheel body of the vehicle of FIG. 1.

FIG. 4 is a front perspective view of the wheel body of FIG. 3.

FIG. 5 is a perspective view of a prior art wheel and its path, traveling through sand.

FIG. 6 is a perspective view of the wheel assembly of FIG. 3, further depicting its path traveling through sand.

FIG. 7 is a front perspective view of the wheel assembly of FIG. 3.

FIGS. 8a-8e are perspective views of the wheel assembly of FIG. 3 at various orientations.

FIG. 9 is a perspective view of a motor vehicle incorporating wheel assemblies in accordance with the invention.

FIG. 10 is a perspective view of an amphibious vehicle incorporating wheel assemblies in accordance with the invention.

FIG. 11 is a perspective view of another embodiment of a wheel assembly in accordance with the invention, the body including a rim and a tire.

FIG. 12 is a front perspective view of another embodiment of a wheel assembly in accordance with the invention, the body of the wheel including eight arc portions in sequential, alternating arrangement about a central hub.

FIG. 13 is a front perspective view of another embodiment of a wheel assembly in accordance with the invention, the body of the wheel including 14 arc portions in sequential, alternating arrangement about a central hub.

### DETAILED DESCRIPTION OF THE PREFERRED EMBODIMENTS

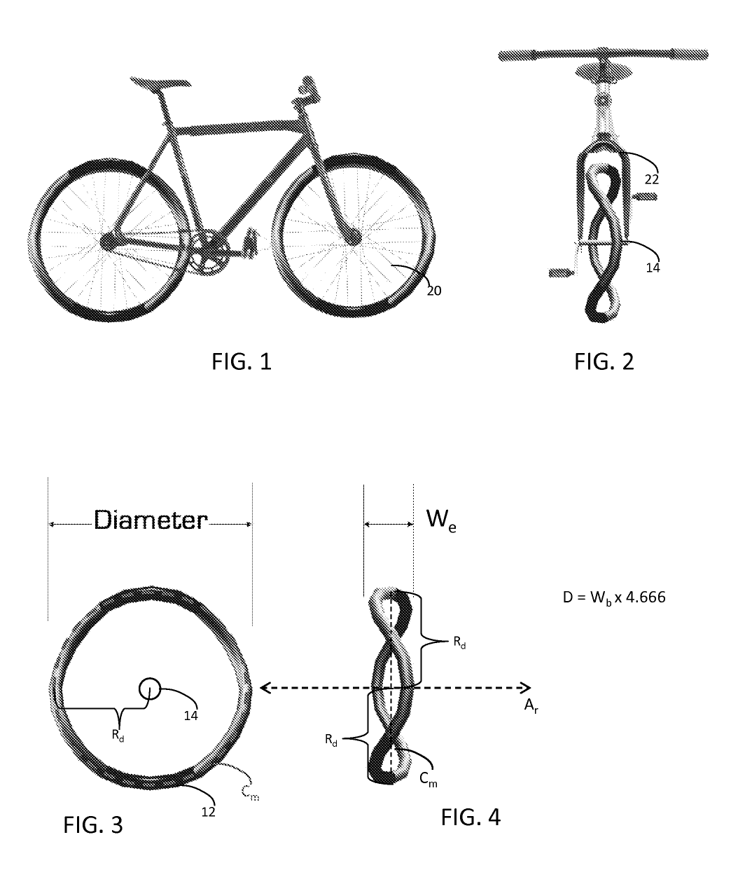

Referring now to the drawings, and particularly FIGS. 1 and 2, there is shown a vehicle, bicycle 20, that includes two wheel assemblies 12, each wheel includes a hub 14 and a body forming an alternating pattern circumscribed about the central hub. The wheel assemblies include a plurality of spokes 20 connects to the hub 14 and projects outwardly along the plane of rotation. The outermost ends of the spokes 20 attach along the inner edge of the body 12. The bicycle 20 includes a front fork 22 sized to accommodate the effective width (Wₑ) of the body. On hard surfaces, the wheel assembly provides a broad track while maintaining a relatively thin contact area. The wheel assembly generates less friction than a traditional wheel with a comparable effective width, since the alternating pattern has less surface area that comes into contact with the ground.

On soft surfaces, e.g., sand, the broad travel path of the wheel assembly enables the vehicle to travel smoothly without unduly sinking into soft material (see, FIGS. 5-7), providing substantial traction. For example, in scenarios in which the wheel begins to slip, the wheel's contact area with the soft surface will increase, up to the effective width (Wₑ), providing additional traction.

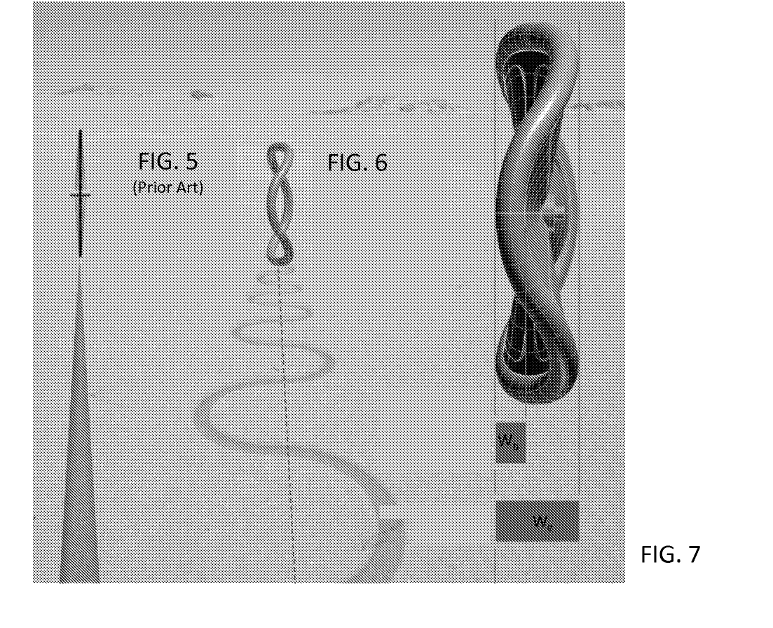

FIG. 7 depicts wheel 12 from a front view. When in motion, the wheel produces an alternating pattern with less frontal surface area, and therefore less fluid dynamic drag, as compared to a wheel of similar width. This alternating pattern also creates an aerodynamic advantage when compared to a circular wheel with spokes of identical width.

With reference to FIGS. 3 and 4, the body 12 is coupled to the central hub 14, to rotate about a primary axis of rotation (Aᵣ) at a constant radial distance (R_{d}) from the axis of rotation. The body 12 defines a median circle (Cₘ) centered on and transverse to the axis of rotation (Aᵣ). The alternating pattern of the body is evenly distributed across the median circle. In the exemplary embodiment, the alternating pattern is a series of alternating curved portions disposed on opposing sides of the median circle, forming a wave pattern having constant amplitude and a constant frequency, relative to the median circle.

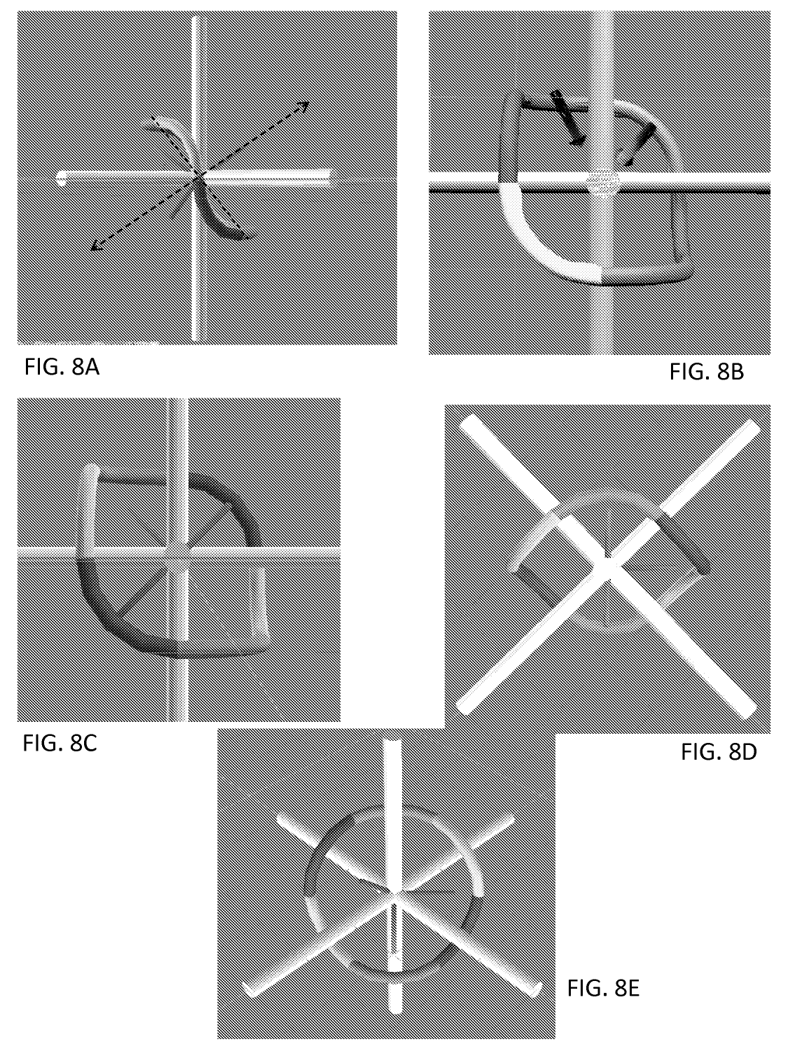

With reference now to FIGS. 8A-E, the body 12 includes six alternating portions in sequential alignment on alternating sides of the median circle (Cₘ). Each portion is shaped as a circular arc having an arc angle of 90 degrees. In the exemplary embodiment, arc portions that are located 180 degrees apart along the body are in parallel orientation to one another, e.g. 12a and 12d. Opposing arc pairs (e.g., 12a & 12d, 12b & 12e, and 12c & 12f) are formed about a shared axis.

The shape of the body can vary in other embodiments. For example, the number and shape of the alternating portions can vary. For example, in FIG. 12 a wheel assembly is depicted that has eight arcs portions disposed in an alternating arrangement about a central hub. In FIG. 13, a wheel assembly is depicted having 14 arc portions disposed in an alternating arrangement about a central hub.

In addition, the amplitude and frequency of the portions can vary across embodiments as well as within an embodiment. Furthermore, the alternating portions need not be limited to a curved shape, any other shape can be used such as squared, pie, or cantilevered portions, among others. Moreover, one or more portions of the body can extend along the median circle at prescribed location(s), interspaced between alternating portion.

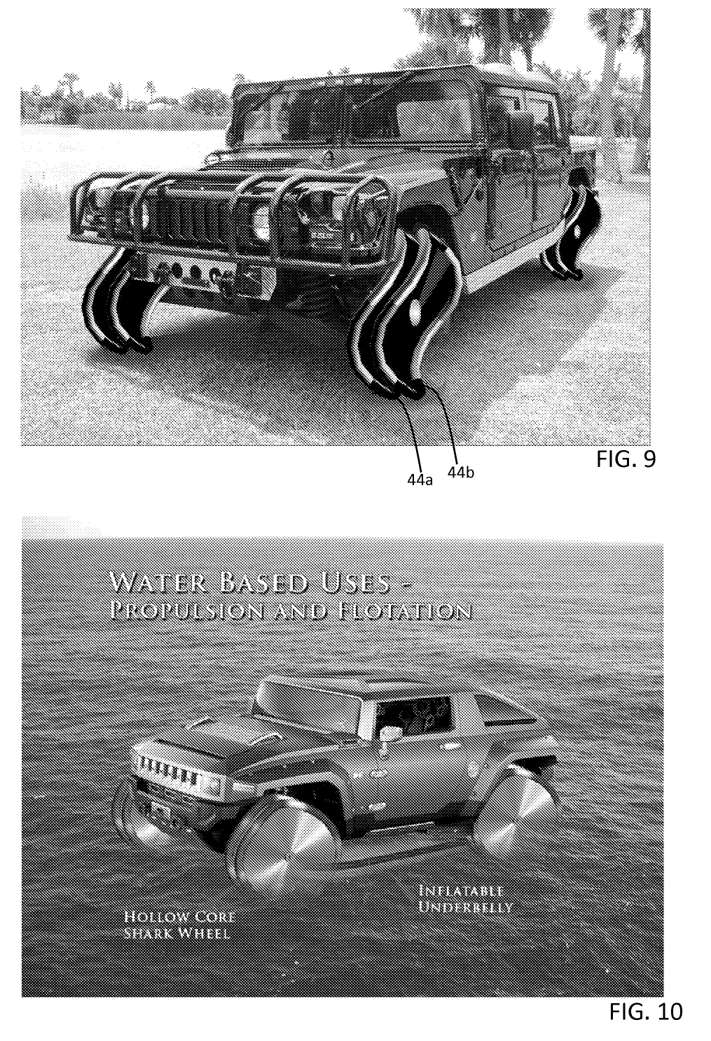

With reference now to FIG. 9, a motor vehicle 40 that includes four dual wheel sets 42. Each wheel set includes a pair of bodies 44(a, b) mounted in alignment with each other. The bodies incorporate the alternating pattern discussed above. The bodies can share a central hub, or the bodies can each have to a separate central hub. In other embodiments incorporating dual wheel configurations, the inner wheel and the outer wheel need not have the same shape or alignment.

With reference now to FIG. 10, an amphibious vehicle 50 that includes four dual wheel sets 42. Each wheel set includes a pair of bodies 44(a, b) mounted in alignment with each other. The bodies incorporate the alternating pattern discussed above. The bodies can share a central hub or can each be mounted to a separate central hub. The body shape of the wheel assemblies can help serve a propulsion means in water. The vehicle 50 includes an inflatable underbelly support 52 mounted to the undercarriage of the vehicle. The support 52 is configured and sized to aid in floatation of the vehicle.

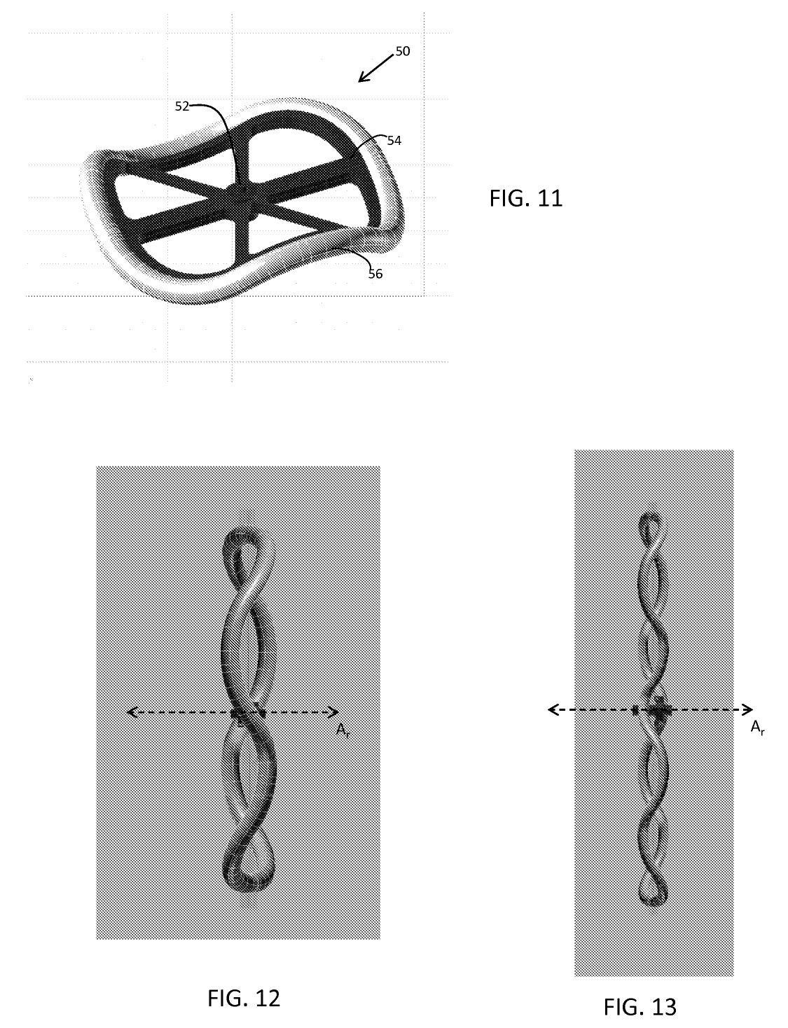

With reference now to FIG. 11, a wheel assembly 50 includes a central hub 52, a rim 54, and a tire 56. The rim and the tire cooperatively define incorporating an alternating pattern as discussed above, the body can accommodate pneumatic tires, which are tires generally made of reinforced rubber and filled with compressed air. In a detailed aspect of an exemplary embodiment, the body provides a rim where a pneumatic tire and inner tube can attach. Alternatively, the body is designed for tubular tires, which attach to the rim through an adhesive or other approaches known in the art. The body can be formed of other variations of tires and rim configurations known in the art can be used without departing from the invention.

Although the invention has been disclosed in detail with reference only to the exemplary embodiments, those skilled in the art will appreciate that various other embodiments can be provided without departing from the scope of the invention. Accordingly, the invention is defined only by the claims set forth below.

What is claimed is:

1. A wheel assembly, comprising:
a central hub defining the axis of rotation; and
a body coupled to the central hub to rotate about the axis of rotation, the body forming an alternating pattern circumscribed about the central hub, the body having a constant radial distance from the axis of rotation.

2. The wheel assembly as defined in claim 1, wherein the alternating pattern of the body defines a median circle at the constant radial distance from the axis of rotation.

3. The wheel assembly as defined in claim 2, wherein the body is formed of a plurality of arcs connected in sequential, adjacent alignment to circumscribe the central hub, each arc having an arc center that is spaced apart from the axis of rotation, such that adjacent arcs have arc center on opposing sides of the body.

4. The wheel assembly as defined in claim 2, wherein the alternating pattern of the body defines a wave pattern having a constant amplitude and a constant frequency, relative to the median circle.

5. The wheel assembly as defined in claim 1, wherein the body has an effective width (Wₑ) to diameter ratio of at least 0.2.

6. The wheel assembly as defined in claim 1, wherein the body defines an effective width (Wₑ) greater than a body width (W_{b}).

7. The wheel assembly as defined in claim 1, further comprising a second body coupled to the central hub positioned adjacent to the first body, the second body mounted to rotate about the axis of rotation, the body forming an alternating pattern circumscribed about the central hub, the alternating pattern of the body defines a median circle centered about the central hub at a constant radial distance from the axis of rotation.

8. A land vehicle having the wheel assembly of claim 1.

9. An amphibious vehicle having wheel assembly of claim 1.

10. A wheel assembly, comprising:
a central hub defining the axis of rotation; and
a body coupled to the central hub to rotate about the axis of rotation, the body having a plurality of arcs connected in sequential, adjacent alignment to circumscribe the central hub, each arc having an arc center that is spaced apart from the axis of rotation, such that adjacent arcs have arc center on opposing sides of the body.

11. The wheel assembly as defined in claim 10, wherein the body defines an effective width (Wₑ) greater than a body width (W_{b}).

12. The wheel assembly as defined in claim 10, wherein each arc of the plurality of arcs has an arc angle of 90 degrees.

13. The wheel assembly as defined in claim 12, wherein the plurality of arcs consists of six arcs.

14. The wheel assembly as defined in claim 10, wherein the plurality of arcs includes more than six arcs.

15. The wheel assembly as defined in claim 10, further comprising a second body coupled to the central hub positioned adjacent to the first body, the second body mounted to rotate about the axis of rotation, the body forming an alternating pattern circumscribed about the central hub, the alternating pattern of the body defines a median circle centered about the central hub at a constant radial distance from the axis of rotation.

16. A vehicle having the wheel assembly of claim 10.

17. A wheel assembly, comprising:
a central hub defining the axis of rotation; and
a body includes a rim coupled to the central hub and a tire mounted to the rim to rotate about the axis of rotation, the body forming an alternating pattern circumscribed about the central hub, the alternating pattern of the body defines a median circle centered about the central hub at a constant radial distance from the axis of rotation.

18. The wheel assembly as defined in claim 17, wherein the alternating pattern is a plurality of arcs connected in sequential, adjacent alignment circumscribing the central hub, each arc having an arc center that is spaced apart from the axis of rotation, such that adjacent arcs have arc center on opposing sides of the body.

19. The wheel assembly as defined in claim 17, further comprising a second body coupled to the central hub positioned adjacent to the first body, the second body mounted to rotate about the axis of rotation, the body forming an alternating pattern circumscribed about the central hub, the alternating pattern of the body defines a median circle centered about the central hub at a constant radial distance from the axis of rotation.

20. The wheel assembly as defined in claim 17, wherein the body defines an effective width (Wₑ) greater than a body width (W_{b}).
